(19) United States
(12) Patent Application Publication
(10) Pub. No.: US 2007/0150409 A1
(43) Pub. Date: Jun. 28, 2007

(54) Unsecured to secured home equity credit conversion system and method

(76) Inventor: Kathryn T. Petralia, Atlanta, GA (US)

Correspondence Address: PHILIP H. BURRUS, IV, 460 Grant Street, Atlanta, GA, 30312, US

(21) Appl. No.: 11/317,211

(22) Filed: Dec. 23, 2005

(51) Int. Cl. G06Q 40/00

(52) U.S. Cl. 705/38

(57) ABSTRACT

A system and method for extending and securing credit with an applicant's equity in real property is provided. An applicant first applies for a home equity line of credit. The necessary documentation and steps to secure credit with an interest in real property can be time consuming. To provide more rapid access of funds to the applicant, after determining whether the applicant is credit worthy, perhaps from a subset of information found on the application for the equity line of credit, the lender extends an unsecured line of credit to the applicant with the understanding that once the additional documentation and steps are completed, the unsecured line of credit will be converted to a secured line of credit. When the additional documentation and steps are completed, the lender files a lien on the applicant's equity interest and converts the unsecured line of credit to a secured line of credit. The lender may additionally provide a credit card with which funds may be drawn on the credit line.

### BACKGROUND

1. Technical Field

This invention relates generally to a system and method for extending credit to a customer, and more particularly to a system and method for extending an unsecured credit line to a customer and converting it to a secured, home equity line of credit at a later date.

2. Background Art

Credit secured by home equity is both a popular and useful financial tool for consumers. By securing a line of credit with the equity vested in one's personal residence, consumers are able to, among other things, consolidate bills, afford down payments on vacation homes, finance renovations, send children to college and care for aging parents. One of the most beneficial aspects to home equity lines of credit is that interest on such loans, under current taxation laws, is often tax deductible.

Despite the intense popularity of home equity lines of credit, however, there are two problems associated with conventional forms of these loans. First, they generally take a long amount of time to acquire. Many steps are involved in the process, including title searches, filing of liens in local courthouses, and the like. Each step is time consuming. For a person who has a sudden emergency, like a relative who requires immediate surgery, they may not be able to afford the time required to complete each of these steps.

The second problem is that lenders who extend offers of home equity lines of credit tend to have depressed response rates. This is related to the first problem, in that the depressed response rates are often due to the time required to complete the paperwork associated with a loan. While a borrower may have initial interest in such a loan, due to the lengthy time it takes to perfect the loan, the borrower may become dissuaded from accepting the lender's offer. This is especially true where, for example, the end of the year is approaching and the borrower requires quick access to deductible interest for tax purposes.

There is thus a need for an improved credit mechanism that is faster in processing so as to provide a borrower with access to funds in a more timely fashion.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a method of securing credit in accordance with the invention.

FIG. 2 illustrates an alternate form of a method for securing credit in accordance with the invention.

FIG. 3 illustrates a method for extending credit in accordance with the invention.

FIG. 4 illustrates a system for extending credit in accordance with the invention.

FIG. 5 illustrates a method for converting an existing customer's line of credit to a secured line of credit.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to extending unsecured credit to an applicant, the unsecured credit to be later secured with the applicant's home equity. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

An embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

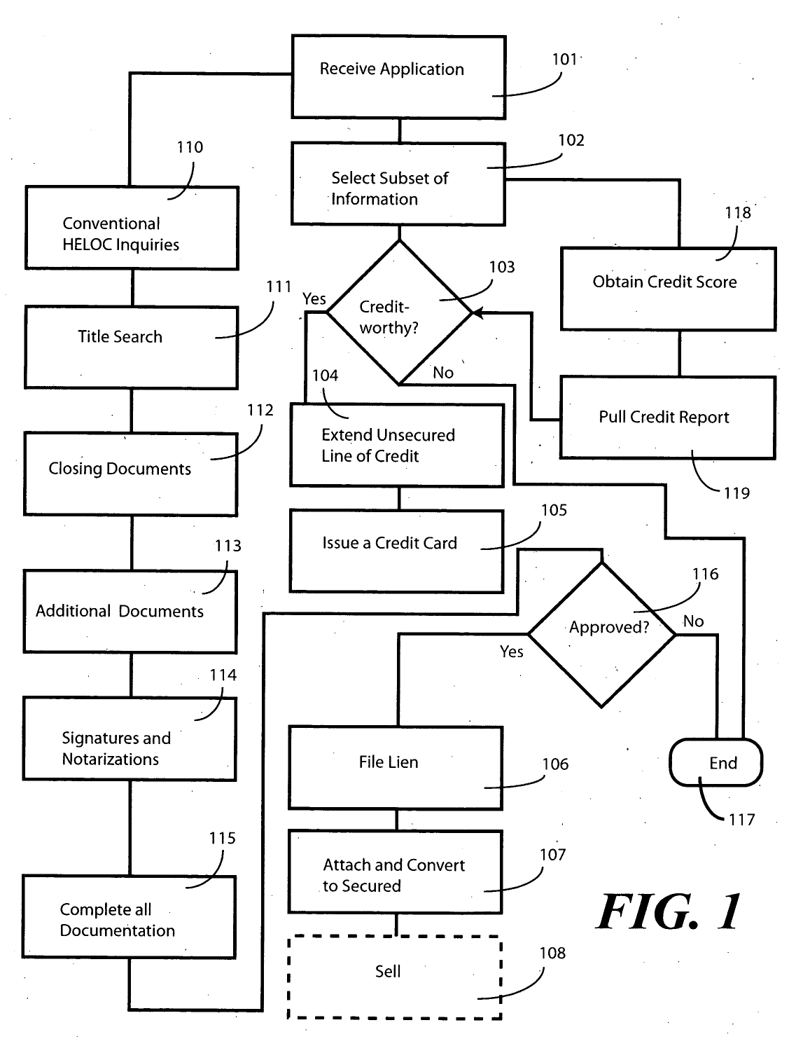

Turning now to FIG. 1, illustrated therein is a method of securing credit in accordance with the invention. The method allows a consumer who applies for a credit line to be secured by the equity in his home to receive an unsecured line of credit while the home equity application is pending. Once additional work is completed, which may include title searches, obtaining notarized signatures and the like, the unsecured line of credit is converted to a secured line of credit. The loan is secured with the customer's home equity by attaching a lien against the customer's primary residence to the unsecured line of credit. The conversion allows the customer to deduct interest on the credit line where permitted by law.

The method as described herein may be completed with the assistance of a computer as will be described in more detail below. For example, the steps recited herein may be programmed as executable code that operates in conjunction with a personal computer. Additionally, the method could be implemented across a network like the Internet. For instance, a customer may be able to apply for a home equity line of credit via a web page or Internet portal. The information may then be transmitted across the network to a central server at the credit provider's site, where it is reviewed and further processed.

At step 101, a customer submits an application for a line of credit to be secured by an applicant's equity interest in a dwelling. The lender receives this application for a line of credit for processing. The application includes information about an applicant. For instance, the application may include name, address, social security number, bank account information, mortgage information and the like. The application may also authorize the lender to attach a lien to the applicant's real property.

At step 102, the lender may select a subset of information from the information about the applicant. While the application for a line of credit to be secured by the applicant's equity interest in a dwelling may have one hundred or more pieces of information, the lender may need only a subset of information to determine whether the applicant is credit worthy. All information could be used, but frequently it will not. For example, by knowing the applicant's name, social security number and date of birth only, the lender may obtain a credit score or credit report for the applicant. Other information may include bank account numbers or primary mortgage information.

At step 103, the lender may determine whether the applicant is credit worthy based upon either all or the subset of information about the applicant. In one embodiment, this step includes obtaining a credit score from a credit bureau, as is shown at step 118, or by obtaining a credit report from a credit bureau, as is shown at step 119. Note that all of the information in the application may be employed to determine whether the applicant is credit worthy. However, the lender may only need a subset, based upon their lending policies, to determine the credit worthiness of an applicant.

At step 104, where the applicant is credit worthy, the lender extends an unsecured line of credit to the applicant. The extension of unsecured credit may be done much more rapidly than the extension of a home equity line of credit, as all the accompanying home equity paperwork need not be completed at the time the unsecured line of credit is extended. In other words, while tasks like performing title searches and the like are completed, the applicant is able to obtain a source of funds in an expedient manner due to the extension of an unsecured credit line.

At step 105, the lender issues the applicant a credit card with which funds may be drawn from the unsecured line of credit. The credit card provides ease of use for the applicant, allowing him to use the credit card to make purchases and obtain cash against the line of credit. In one embodiment, the step of issuing the credit card for the unsecured line of credit will include the step of assigning an account number to identify the unsecured line of credit. This account number may be embossed on the credit card itself. A lender will perform, in one embodiment, the step of issuing the credit card for the unsecured line of credit. The issuance of the credit card, as well as the extension of unsecured credit, may include a set of terms and conditions by which the borrower is accepting the line of credit.

Note that while the applicant has access to the unsecured line of credit, additional home equity documentation, i.e. documentation necessary to facilitate a security interest lien, may be completed at steps 110-114. Note that these steps, steps 110-114 are exemplary in nature only, as each lender may complete the additional documentation differently. Exemplary additional steps include running conventional credit checks at step 110, performing a title search at step 111, completing closing documents at step 112, completing additional documentation at step 113 and obtaining the necessary signatures and notarizations where necessary at step 114.

Other documentation required to facilitate the security interest lien being placed upon the dwelling may include: a promissory note executed by the applicant, a purchase and sale agreement, a bill of sale, a property inspection report, a title search report, a credit estimate under the Real Estate Settlement Act of 1974, a residential loan application, a loan payment schedule, a notice of transfer of servicing rights, an escrow account disclosure statement, a truth in lending disclosure statement, a security deed, a waiver of borrower's rights, a creditor's affidavit, a request for taxpayer identification number, a request for copy of tax forms, a signature affidavit, an anti-coercion statement, a survey, a survey waiver request, an affidavit of seller, an error and omissions compliance agreement, a power of attorney, a residential loan application, an interest rate agreement, a wood infestation report, a hold harmless agreement, an agreement regarding property taxes, and a property appraisal.

At step 115, after issuing the credit card, the additional documentation necessary to facilitate a security interest lien being placed upon the applicant's dwelling is completed. Note that this occurs after the extension of the unsecured line of credit because the lender is able to determine whether the applicant is credit worthy in a far shorter time than it takes bankers, financiers and attorneys to complete all the documentation associated with a loan secured by an interest in real property.

In one embodiment, where this additional documentation is being completed, it should be noted that no additional underwriting is required. Where the line of credit is converted to a secured line, this step may be accomplished without any additional underwriting by the lender.

At step 106, the lender files a lien upon the dwelling. The lien can now be filed as all of the prerequisite documentation has been completed. The filing of the lien may be as simple as creating a security interest upon execution of a consent document by the applicant. Alternatively, the step of converting the unsecured line of credit to a secured line of credit by attaching the lien may include recording a security interest with a local authority. For instance, the filing of the lien may be accomplished by recording the loan with the appropriate governmental agency. One example would be filing a record of the loan in the courthouse of the county in which the dwelling is located.

Upon filing the lien, the unsecured line of credit may be converted to a secured line of credit by attaching the lien to the unsecured line of credit at step 107. In one embodiment, where an account number was assigned to identify the unsecured line of credit, the same account number will be used to identify the secured line of credit. Also, in one embodiment, where a lender issued the credit card, when the credit line is converted to a secured line of credit, the lender will remain unchanged. In such cases, where the credit card was available for drawing funds from the unsecured credit, the credit card may still be used to draw funds from the secured line of credit. Further, the terms and conditions associated with the unsecured line of credit may remain unchanged and in effect once the credit line has been converted to a secured line of credit.

Once the line has been converted to a secure line, the lender is now satisfied in that he has a security interest in the credit line that has been extended to the applicant. In one embodiment, the lender did not need to underwrite the loan to obtain the security interest. Additionally, the applicant is satisfied in that he can now deduct interest payments where permitted by law.

Additional steps may be completed after the unsecured line of credit has been converted to a secured line of credit. For example, as the credit line now represents a mortgage interest on the applicant's dwelling, the primary lender may sell the mortgage on the open market, as indicated in step 108. Stated differently, the step of converting the unsecured line of credit to a secured line of credit by attaching the lien may include selling the unsecured line of credit to a purchaser. The purchaser may be a mortgage underwriter. A buyer may also bundle the mortgage with others, securitize the bundle and offer the securities to investors.

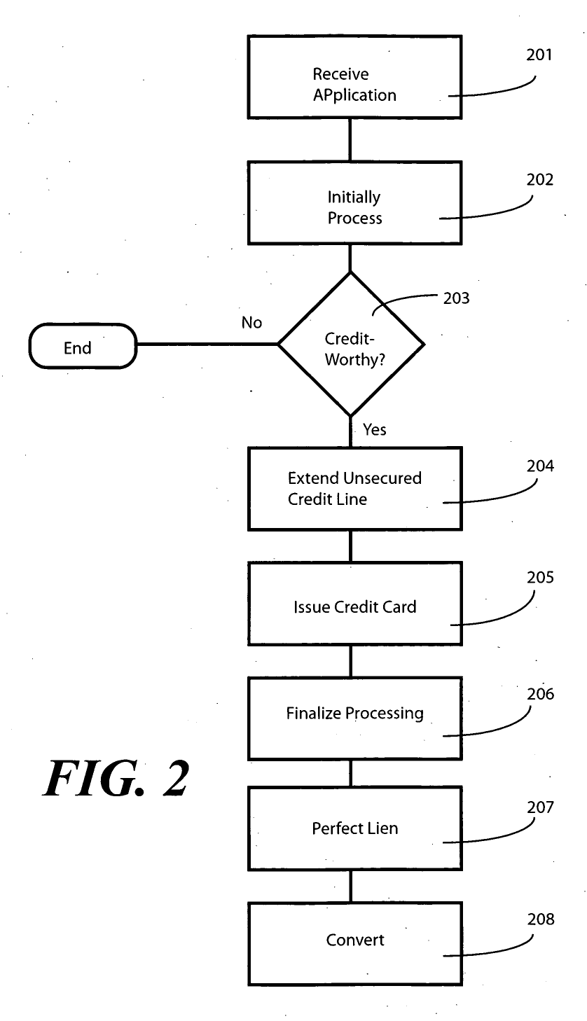

Turning now to FIG. 2, illustrated therein is an alternate form of a system and method for securing credit in accordance with the invention. At step 201, an application for a home equity line of credit is received. As noted above, an applicant may submit such an application electronically, perhaps through a personal computer via the Internet. The application may also be submitted in paper form.

At step 202, the lender initially processes the application. The initial processing may include scanning or inputting by data entry to load the application into a database. The initial processing may also include contacting and initiating other systems and processes needed to process the application, including title inspectors, credit bureaus, banking systems, investigative systems and informational databases.

At step 203, the lender decides whether the applicant is credit worthy. As noted above, this may be done in many different ways. It could be a quantitative analysis, perhaps by analyzing a credit score. It may be qualitative, perhaps by analyzing letters of reference. Alternatively, it may be a combination of the two. In one embodiment, the step of determining credit worthiness comprises requesting a credit report from a credit bureau. In another embodiment, the step of determining credit worthiness includes selecting a subset of information from information on the application for the home equity line of credit. The subset selected includes a name, a social security number and an address.

At step 204, provided the applicant is credit worthy, the lender extends the applicant an unsecured line of credit. The line of credit is not secured by the applicant's home equity because the necessary paperwork to effect such a security has not been completed. However, to provide the applicant with quicker access to funds, the lender extends an unsecured line of credit to the user with the understanding that once the home equity effecting paperwork is completed, a home equity lien will be attached to the credit line.

At step 205, the lender issues a credit card with which funds may be drawn from the unsecured line of credit. The credit card allows the applicant to easily and conveniently draw funds, eliminating the need for a pass or check book, superfluous deposits and long check clearing times.

At step 206, after the unsecured credit and associated credit card have been offered, the process of completing the documentation and other requirements for the home equity line of credit may be completed. At step 207, the lien on the applicant's home equity may be perfected by filing a lien upon a home indicated in the application for a home equity line of credit. At step 208, the unsecured line of credit is converted to a home equity line of credit by attaching the lien to the unsecured line of credit. In one embodiment, the step of converting the unsecured line of credit to a home equity line of credit includes recording a security interest with a local authority. One example of such a local authority, as noted above, is the county courthouse in which the home is situated.

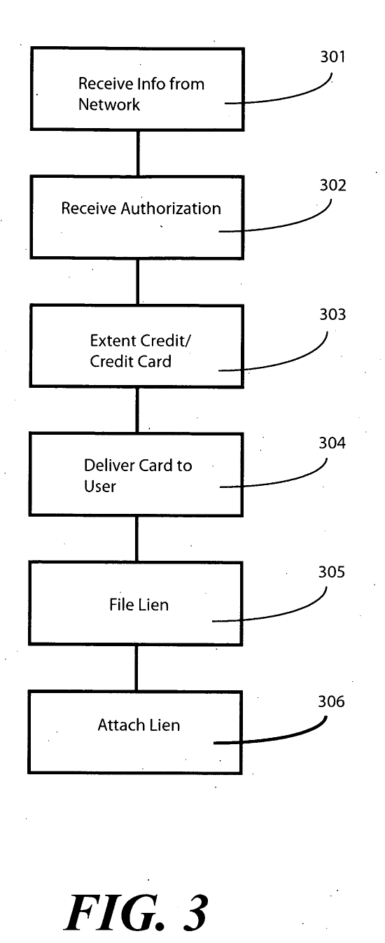

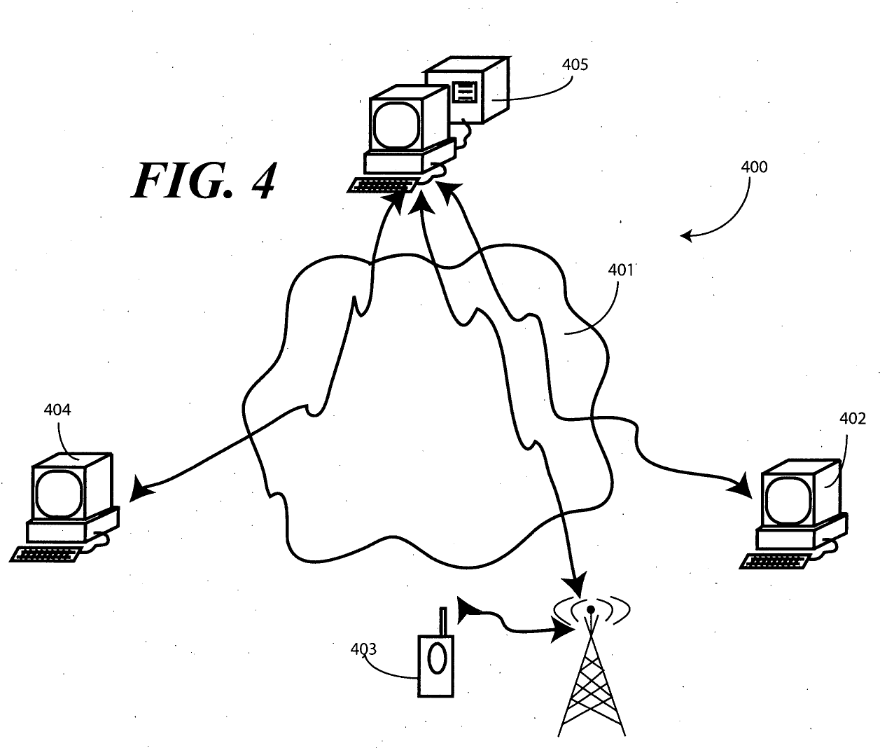

Turning now to FIGS. 3 and 4, illustrated therein is an alternate method of extending a loan in accordance with the invention. The method of FIGS. 3 and 4 illustrate a method of extending a loan with the assistance of a computer. FIG. 3 illustrates the method, while FIG. 4 illustrates a system in accordance with the method.

Starting with FIG. 4, illustrated therein is a system 400 for providing applicants with credit secured with equity in their homes in accordance with the invention. The system 400 includes a network 401, like the Internet, World Wide Web, TCP/IP or UMS network for example, and one or more applicant terminals 402-404. The system 400 may include any of a number of intermediate processing components for communicating with the applicant terminals 402-404. These processing components may include electronic switches, relays, servers and computers for facilitating the transactions across the network 401.

The applicant terminals 402-404 may take many forms, including computers, workstations, telephones, cellular telephones, personal digital assistants, portable computers, or any other devices capable of interfacing with a communications network. The applicant may employ the terminals 402-404 to transmit and receive information to and from the lender's server 405.

Turning back to FIG. 3, a method associated with the system of FIG. 4 is illustrated therein. At step 301, personal and financial information, like a home equity line of credit application, is received via the network. The applicant may enter information by way of a secure website, and transmit it to the lenders server across the network for automated processing.

At step 302, the applicant transmits authorization to secure a loan with real estate equity belonging to the applicant. As the application for credit and the authorization to secure the credit are associated with each other, the two may be sent in a single step. However, certain local authorities may have regulations associated with subjecting real property to creditors. In those cases, a separate step may be required.

At step 303, the lenders system extends an unsecured line of credit to the user, wherein funds can be drawn from the unsecured line of credit by way of a credit card. This extension of credit may be actuated by a program operating within the lender's information technology system that prints a credit notice, inserts or orders a card, and causes the package to be either electronically transmitted, mailed or otherwise delivered to the applicant at step 304.

At step 305, the lender files a lien against the real estate equity after extending the unsecured line of credit to the user. While this may be done electronically, by printing a notice and causing it to be mailed to the proper recipients, it may additionally include other steps, like recording the lien in the county courthouse. At step 306, the lender attaches the lien to the unsecured line of credit, thereby converting the unsecured line of credit to a secured, real estate equity line of credit.

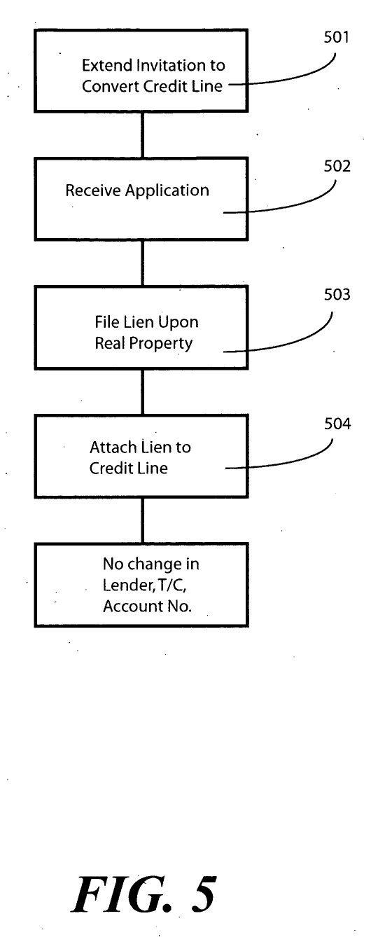

Turning now to FIG. 5, illustrated therein is a method for converting an existing customer's unsecured credit line into a secured line of credit. The method is applicable, for example, where a lender has extended an unsecured line of credit to a borrower and later the borrower desires to convert the credit line to a secured line. Such a conversion may be desireable where applicable tax laws provide for deductions of certain forms of interest.

At step 501, as the borrower already has the line of credit, the lender extends an invitation for the borrower to convert the unsecured line of credit to a secured line of credit. Should the borrower accept, the borrower completes the required documentation and returns it to the borrower.

At step 502, the lender receives the application for a home equity line of credit. At step 503, the lender files a lien upon the real property. At step 504, the lender attaches a lien to the unsecured line of credit, thereby converting the unsecured line of credit to a secured line of credit. Where the lender had an account number assigned to the unsecured line of credit, the account number assigned to the unsecured line of credit may be used to identify the secured line of credit. Further, the lender may remain unchanged after the step of attaching the lien. Additionally, where a set of terms and conditions was attached or associated with the unsecured line of credit, that same set of terms and conditions may remain in effect after the step of attaching the lien.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A method of securing credit, the method comprising the steps of:
a. receiving an application for a line of credit;
b. issuing the applicant a credit card for an unsecured line of credit;
c. after the step of issuing the credit card, completing additional documentation necessary to facilitate a security interest lien being placed upon real property; and
d. filing a lien upon the real property; and
e. attaching the lien to the unsecured line of credit, thereby converting the unsecured line of credit to a secured line of credit.

2. The method of claim 1, wherein the application for the line of credit comprises an application for a home equity line of credit.

3. The method of claim 1, wherein the step of issuing the credit card for the unsecured line of credit comprises the step of assigning an account number to identify the unsecured line of credit, wherein the account number assigned to identify the unsecured line of credit is used to identify the secured line of credit.

4. The method of claim 1, wherein the step of issuing the credit card for the unsecured line of credit is performed by a lender, wherein after the step of attaching the lien to the unsecured line of credit, the lender is unchanged.

5. The method of claim 1, wherein after the step of attaching the lien to the unsecured line of credit, the credit card for the unsecured line of credit may be used to draw funds from the secured line of credit.

6. The method of claim 1, wherein the step of issuing the credit card for the unsecured line of credit comprises extending a set of terms and conditions to an applicant, wherein after the step of attaching the lien to the unsecured line of credit, the set of terms and conditions remains unchanged and in effect.

7. The method of claim 1, wherein the additional documentation necessary to facilitate the security interest lien being placed upon the real property is selected from the group consisting of a promissory note executed by the applicant, a purchase and sale agreement, a bill of sale, a property inspection report, a title search report, a credit estimate under the Real Estate Settlement Act of 1974, a residential loan application, a loan payment schedule, a notice of transfer of servicing rights, an escrow account disclosure statement, a truth in lending disclosure statement, a security deed, a waiver of borrower's rights, a creditor's affidavit, a request for taxpayer identification number, a request for copy of tax forms, a signature affidavit, an anti-coercion statement, a survey, a survey waiver request, an affidavit of seller, an error and omissions compliance agreement, a power of attorney, a residential loan application, an interest rate agreement, a wood infestation report, a hold harmless agreement, an agreement regarding property taxes, and a property appraisal.

8. The method of claim 1, further comprising the step of determining whether an applicant is credit worthy, wherein the step of determining whether the applicant is credit worthy comprises at least one of obtaining a credit rating score from a credit bureau and requesting a credit report from a credit bureau.

9. The method of claim 1, further comprising the step of selling the unsecured line of credit to a purchaser.

10. The method of claim 1, wherein the step of attaching the lien comprises recording a security interest with a local authority.

11. A method of securing credit, comprising:
a. receiving an application for a home equity line of credit;
b. initially processing the application for the home equity line of credit;
c. determining a credit worthiness from information found in the application for the home equity line of credit;
d. extending an unsecured line of credit;
e. issuing a credit card with which funds may be drawn from the unsecured line of credit;
f. after issuing the credit card, completing processing for the home equity line of credit;
g. filing a lien upon a home indicated in the application for a home equity line of credit; and
h. converting the unsecured line of credit to a home equity line of credit by attaching the lien to the unsecured line of credit.

12. The method of claim 11, wherein the step of initially processing the application for the home equity line of credit comprises loading information from the application for home equity line of credit into a database, further wherein the step of determining credit worthiness comprises obtaining a credit rating score from a credit bureau.

13. The method of claim 11, wherein the step of determining credit worthiness comprises requesting a credit report from a credit bureau.

14. The method of claim 11, wherein the step of determining credit worthiness comprises selecting a subset of information from information on the application for the home equity line of credit, wherein the subset of information is selected from the group selected of a name, a social security number and an address.

15. The method of claim 11, wherein the step of converting the unsecured line of credit to a home equity line of credit comprises recording a security interest with a local authority.

16. A method of extending a loan with the assistance of a computer, the method comprising the steps of:
a. receiving personal and financial information from a user through a network;
b. receiving an authorization to secure the loan with real estate equity;
c. extending an unsecured line of credit to the user, wherein funds can be drawn from the unsecured line of credit by way of a credit card;
d. delivering the credit card to the user;
e. filing a lien against the real estate equity after extending the unsecured line of credit to the user; and
f. attaching the lien to the unsecured line of credit, thereby converting the unsecured line of credit to a secured, real estate equity line of credit.

17. The method of claim 16, wherein the network is selected from the Internet and the World Wide Web.

18. The method of claim 17, wherein the real estate equity. comprises an equity interest in an applicant's primary residence.

19. The method of claim 18, wherein the step of attaching the lien to the unsecured line of credit comprises filing notice of the lien in county courthouse.

20. Where a lender has extended an unsecured line of credit to a borrower, a method for converting the unsecured line of credit to a secured line of credit, the method comprising the steps of:
a. extending an invitation for the borrower to convert the unsecured line of credit to a secured line of credit;
b. receiving an application for a home equity line of credit;
c. filing a lien upon the real property; and
d. attaching the lien to the unsecured line of credit, thereby converting the unsecured line of credit to a secured line of credit;
wherein an account number assigned to the unsecured line of credit is used for to identify the secured line of credit;
wherein the lender remains unchanged after the step of attaching the lien; and
wherein a set of terms and conditions associated with the unsecured line of credit remains in effect after the step of attaching the lien.
